(19) United States
(12) Patent Application Publication
(10) Pub. No.: US 2009/0287677 A1
(43) Pub. Date: Nov. 19, 2009

(54) STREAMING MEDIA INSTANT ANSWER ON INTERNET SEARCH RESULT PAGE

(75) Inventors: SERGEY MARKOV, BELLEVUE, WA (US); ANDREY ZAYTSEV, SAMMAMISH, WA (US); NIKITA SHAMGUNOV, REDMOND, WA (US); JIN YAMAMOTO, BELLEVUE, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/122,421

(22) Filed: May 16, 2008

(51) Int. Cl. G06F 7/06; G06F 3/048; G06F 17/30

(52) U.S. Cl. 707/5; 715/781; 707/104.1; 715/810; 707/E17.009; 707/E17.01; 707/E17.017

(57) ABSTRACT

A method and medium are provided for presentation of media to a user. In one embodiment of the invention, a search query is received containing descriptors of one or more aspects of media. A search is then conducted for sources of media generated in real time that satisfy the search query. Regular, algorithmic search results may be generated as well. An interface for the presentation of the sources of media is then integrated into a search results web page. Upon selecting a source of media in the interface, the source is presented to the user. Sources of media generated in real time may then be presented to a user without the need of navigating away from the search results page. Other embodiments of the invention are directed to receiving and indexing sources of streaming media based on their respective content to aid in satisfying search queries for streaming media.

### BACKGROUND

Users often issue search queries to search engines when seeking various types of information. Search engines in return then provide a list of search results to the user. The search results may be generated according to algorithms. However, when the search query contains a question, the search engine may generate and return an ‘answer’ to the user issuing the query in conjunction with a list of regular search results. Examples of such queries are “Seattle weather” or “five miles to feet.” In each instance, an ‘answer’ is provided to the search query. In the “Seattle weather” example, the current weather and short-term forecast for Seattle, Wash. may be displayed, along with regular search results. In the “five miles to feet” example, the number of feet in five miles may be displayed, along with regular search results. In both examples, the user is then able to receive the ‘answer’ to their search query without navigating away from the list of search results.

When presented with a search query that describes aspects of media being sought, search engines do not generate an ‘answer’ as described in the examples above. Rather, in response to queries of this type, search engines generate regular search results based on search algorithms.

### SUMMARY

In one aspect of the present invention, methods and computer-storage media for presenting media to a user in response to a search query are provided. Search queries are received that describe aspects of media that a user is seeking. A search is then conducted for media satisfying the search query. In some embodiments of the invention, the media that a user is seeking may be generated in real time. An interface is then provided for presenting sources of media to the user in conjunction with regular search results. A user may then select and be presented with a source of media without navigating away from the search results page.

In a second aspect, methods are provided for the reception of multiple sources of streaming media and subsequent grouping of the sources based on their respective content. An index may then be generated for the sources of media and their respective content. When receiving a search query seeking streaming media, the index is then consulted in determining which sources of streaming media satisfy the search query. After receiving the search query and determining which sources of streaming media satisfy the query, a list of regular search results may then be presented in conjunction with an interface for the presentation of the sources of streaming media. A user is then able to select a source of streaming media for presentation without navigating away from the search results page.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 is a block diagram illustrating an overview of a system in accordance with an embodiment of the invention;

FIG. 2 is a diagram illustrating a computer networking environment, according to one embodiment of the invention;

FIG. 3 is a diagram depicting a screen shot, according to an embodiment of the present invention;

FIG. 4 is a diagram depicting a screen shot, according to an embodiment of the present invention;

FIG. 5 is a diagram depicting a screen shot, according to an embodiment of the present invention;

FIG. 6 is a block diagram illustrating a method of presenting media, according to an embodiment of the present invention;

FIG. 7 is a block diagram illustrating a method for presenting media, according to an embodiment of the present invention; and

FIG. 8 is a block diagram illustrating a method for presenting streaming media to a user, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to computer-readable storage media having computer-useable instructions embodied thereon for performing a method of presenting media. The presented media is generated in real time, by one or more providers. The media can be audio or visual media, and is of the type that is communicated by the one or more providers on a continuous basis to a plurality of users. One example of a provider is a broadcast radio or television station that communicates media being generated in real time to a plurality of users. Providers of media being generated in real time, as discussed and contemplated herein, are NOT repositories of media that are available for users to search and be presented with media content in response to their search. Such repositories present media files that are static in nature, and are not generated in real time. Examples of these repositories are video sharing web sites and the like where users upload media files that are stored on one or more servers. Users may then view the media files at their leisure, on an individual, user by user basis.

The repositories differ from the providers of media generated in real time because the repositories store media content and permit users to start the playback of media content individually, on a user by user basis. The providers of media being generated in real time differ in that a stream of media content is generated in real time, and a user can only listen or watch the stream of media content in real time. These repositories of media are not generated in real time and are fundamentally different than the providers of media as contemplated herein.

The method comprises receiving a search query, searching for media to satisfy the search query, determining one or more providers of media that satisfy the search query, and presenting an interface at a computing device of a user for the presentation of said media. The interface is presented in conjunction with one or more URLs satisfying the search query.

Another embodiment of the present invention is directed to receiving a search query, searching for media to satisfy the search query, determining one or more sources of media that satisfy the search query, and presenting an interface for the presentation of the media. The interface is presented in conjunction with one or more URLs of search results to satisfy the search query.

Another embodiment of the present invention is directed to a method of presenting streaming media. The method comprises receiving streaming media transmitted by one or more providers of streaming media, generating one or more indices grouping the received streaming media based on their respective content, receiving a search query, and generating a list of search results that satisfy the search query by consulting the one or more indices. The list of search results is embedded with an interface for presenting streaming media that satisfies the search query. The streaming media is presented to the user upon the user selecting one or more of the sources. The presenting occurs without the user navigating away from the list of search results.

Embodiments of the present invention may be embodied as, among other things: a method, system, or computer-program product. Accordingly, the embodiments may take the form of a hardware embodiment, a software embodiment, or an embodiment combining software and hardware. In one embodiment, the present invention takes the form of a computer-program product that includes computer-useable instructions embodied on one or more computer-readable media.

Having briefly described an overview of embodiments of the present invention, an exemplary operating environment suitable for use in implementing embodiments of the present invention is described below.

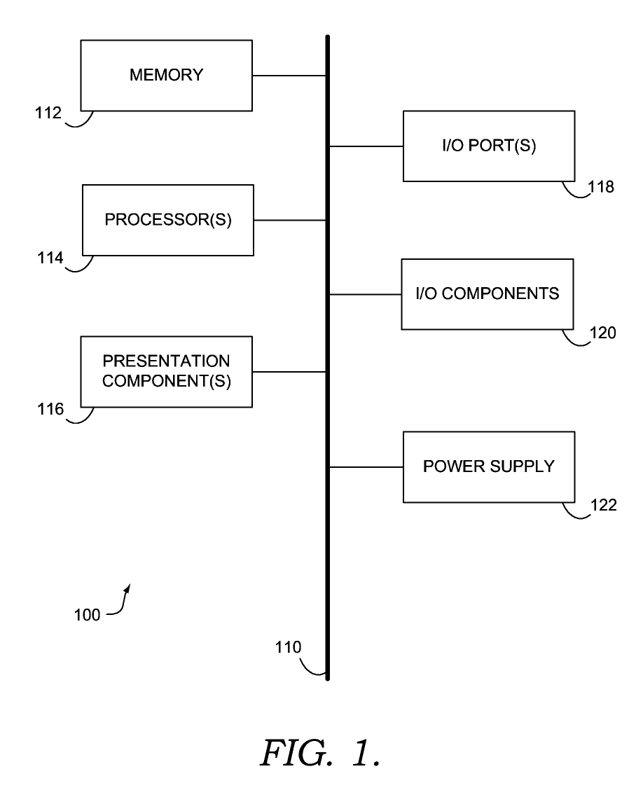

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the illustrated computing environment be interpreted as having any dependency or requirement relating to any one or combination of components/modules illustrated.

The invention may be described in the general context of computer code or machine-useable instructions, including computer-executable instructions such as program components, being executed by a computer or other machine, such as a personal data assistant or other hand-held device. Generally, program components including routines, programs, objects, components, data structures, and the like, refer to code that performs particular tasks, or implements particular abstract data types. Embodiments of the present invention may be practiced in a variety of system configurations, including hand-held devices, consumer electronics, general-purpose computers, specialty-computing devices, and the like. Embodiments of the present invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices; or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disk drives, and the like. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game advertisement, satellite dish, scanner, printer, wireless device, and the like.

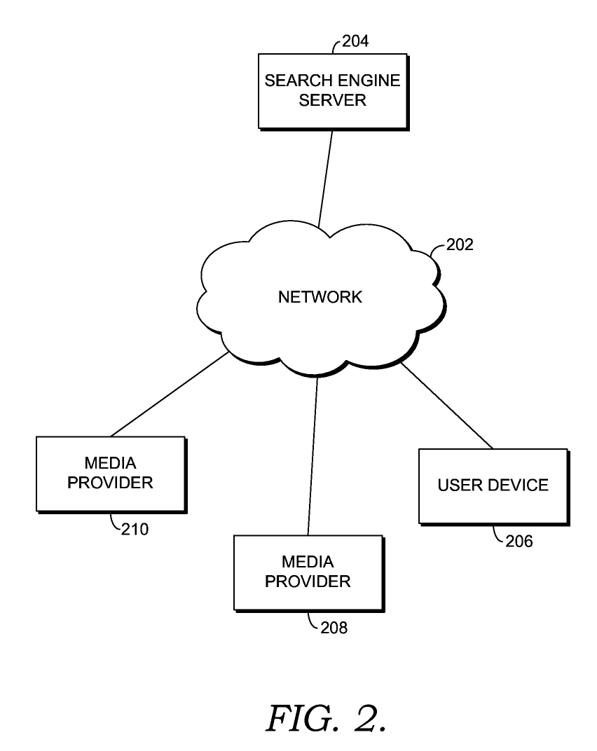

Turning now to FIG. 2, a computer networking environment is presented, according to one embodiment of the invention. Network 202 connects media providers 210 and 208, search engine server 204, and user device 206. Network 202 can be a wide area network (WAN), local area network (LAN), intranet, the internet, or any other network that serves to enable communication between the components depicted in FIG. 2.

Search engine server 204 is a server that receives search queries issued by the user device 206. While only one user device 206 is depicted, it should be understood that any number of user devices can communicate through the network 202 to the search engine server 204. Search queries can contain descriptors that define the content that a user of the user device 206 is seeking. The search engine server 204 analyzes these queries by using search algorithms and communicates, through the network 202 to the user device 206, a list of search results that contain the content the user of the user device 206 is seeking. The search results can take the form of links to URLs and can be embedded in a search results page.

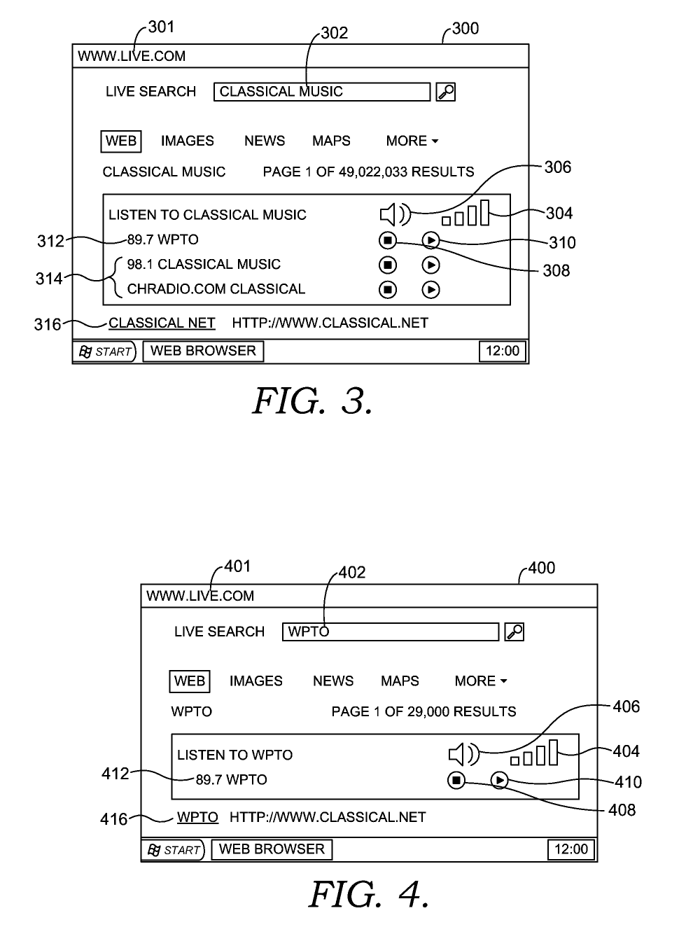

The search results can also contain media received from media providers 208 and 210. The conditions and methods of presenting media received from media providers 208 and 210 in conjunction with search results generated by the search engine server 204 will be discussed in greater detail in relation to FIGS. 3-8.

The media providers 210 and 208 can provide sources of media being generated in real time. For example, these sources may be broadcast radio stations, television stations, internet streaming visual media providers, internet radio stations, or any other source of media that is generated in real time. While specific examples may be made to types of audio media and radio stations through this specification, neither should be construed as limiting. The invention contemplates all types of media, including video. Additionally, the foregoing figures and discussion make reference to sources of media including music, but embodiments of the invention also provide for sources of media that are not limited to music and are further not limited to strictly audible forms of media. Such sources can include, by way of example only, news, weather, sporting events, or general programming. Accordingly, this invention contemplates all types of streaming media, both visual and audio and combination thereof.

The foregoing FIGS. 3, 4, and 5 are directed to embodiments of the invention for presenting streaming media in an audio format. In embodiments of the invention that present visual streaming media, a portion of the user interface would be utilized to display the visual streaming media. This can take the form of set portion of the user interface being reserved for the visual streaming media that is defined by predefined dimensions. The dimensions can be specified in pixels or any other suitable format. The dimensions of the reserved portion of the user interface can also be adjustable by a user of the user device 206. The dimensions can also be specified by the provider of the streaming media.

In other embodiments of the invention, the streaming media may not be displayed on the search results page and instead the user can be presented with a short cut to launch a stand-alone media player on the computing device 100. The stand-alone media player would then receive the streaming media from the media providers 208 and 210 and present it to the user of the user device 206.

Turning now to FIG. 3, an exemplary diagram depicting a screen shot is presented according to one embodiment of the present invention. User interface 300 includes a window 301 depicting a set of search results generated by search engine server 204 and communicated for presentation on the user device 206 through the network 202. Search query 302 is depicted in the window 301 and contains descriptors of content that the user of the user device 206 is seeking. The search query 302 would have been initially entered on a home page of the search engine server 204, not depicted in the figures.

The search query 302 presented in FIG. 3 contains the elements “classical music” that define the content of media being sought. By using one or more search algorithms, the search engine server 204 presents sources of media 312 and 314 provided by media providers 208 and 210. The sources of media 312 and 314 are presented in conjunction with regular search results 316 that provide links to URLs. Although only one regular search result 316 is presented in FIG. 3, any number of regular search results can be presented, according to embodiments of the present invention. In the current embodiment of the invention, the one or more search algorithms provide search results and sources of media 312 and 314 that are relevant to the search query 302 of “classical music.” As the search query 302 does not contain a reference indicating a particular source of media that is being sought, the most relevant sources of media 312 and 314 are presented to the user.

Upon being presented search results in window 301, a user of the user device 206 can select one of the sources of media 312 and 314, or the user can select one of the search results 316 to be redirected to a URL referenced by the particular search result 316. The user can select one of the sources of media 312 and 314 by double clicking on the visual indication of the particular source of media in the window 301. The double clicking can be accomplished by any suitable user-input device. The user can alternatively select the play icon 310 to select one of the sources of media 312 and 314. Upon receiving a selection of the one or more sources of media 312 and 314, media generated by the corresponding media provider 208 and 210 is presented to the user of the user device 206. The user can select a different source of media 312 or 314 by the same method employed to initially select one of the sources of media 312 or 314. Additionally, a user may select to cease to be presented with a source of media 312 or 314 by selecting the stop icon 308 for the corresponding source of media 312 or 314.

Speaker control 306 provides for muting the audio of the selected sources of media 312 and 314 that are being presented to the user of the user device 206. Volume control 304 permits a user to adjust the volume of the selected sources of media 312 and 314.

In other embodiments of the invention that utilize visual sources of streaming media, users can be presented with additional visual sources of media (not shown in the figures). For example, if a user search query of “professional baseball”, a list of search results can be generated that include visual sources of streaming media. The list of search results can also include sources of audio streaming media. In this example, visual sources of streaming media can include streaming broadcasts dealing with professional baseball, such as games between two teams, news reports concerning professional baseball, or any other visual streaming media that would be properly categorized as pertaining to professional baseball. Additionally, a user can present a more specific search query, such as the name of a professional baseball team. In this embodiment, the list of search results would include sources of visual streaming media relating to that particular professional baseball team. This could include a game in which the team was playing, a news story concerning the team, an interview of a player on the team, or any visual or audio streaming media that pertains to the professional baseball team.

Turning to FIG. 4, an exemplary diagram depicting a screen shot is presented according to one embodiment of the present invention. User interface 400 includes a window 401 depicting a set of search results generated by search engine server 204 and communicated for presentation on the user device 206 through the network 202. Search query 402 is depicted in the window 401 and contains descriptors of content that the user of the user device 206 is seeking. The search query 402 would have been initially entered on a home page of the search engine server 204, not depicted in the figures.

The search query 402 presented in FIG. 4 contains the elements “WPTO” that define the content of media being sought. In this embodiment of the invention, the elements “WPTO” define a call sign of a radio station. By using one or more search algorithms, the search engine server 204 presents source of media 412, provided by media providers 208 or 210. As the search query 402 provides an indication of a particular source of media being sought by the user of the user device 206, only the particular source of media is presented in the search results in window 401. This is in contrast to the embodiment of the invention presented in FIG. 3, in which a more generic search query 302 of “classical music” was presented.

The source of media 412 is presented in conjunction with regular search results 416 that provide links to URLs. Although only one regular search result 416 is presented in FIG. 4, any number of regular search results can be presented, according to embodiments of the present invention.

Upon being presented search results in window 401, a user of the user device 206 can select the source of media 412, or the user can select one of the search results 416 to be redirected to a URL referenced by the particular search result 416. The user can select the source of media 412 by double clicking on the visual indication of the source of media in the window 301. The double clicking can be accomplished by any suitable user-input device. The user can alternatively select the play icon 410 to select the source of media 412. Upon receiving a selection of the source of media 412, media generated by the corresponding media provider 208 or 210 is presented to the user of the user device 206. The user may select to cease to be presented with the source of media 412 by selecting the stop icon 408 for the source of media 412.

Speaker control 406 provides for muting the audio of the source of media 412 that is being presented to the user of the user device 206. Volume control 404 permits a user to adjust the volume of the source of media 412.

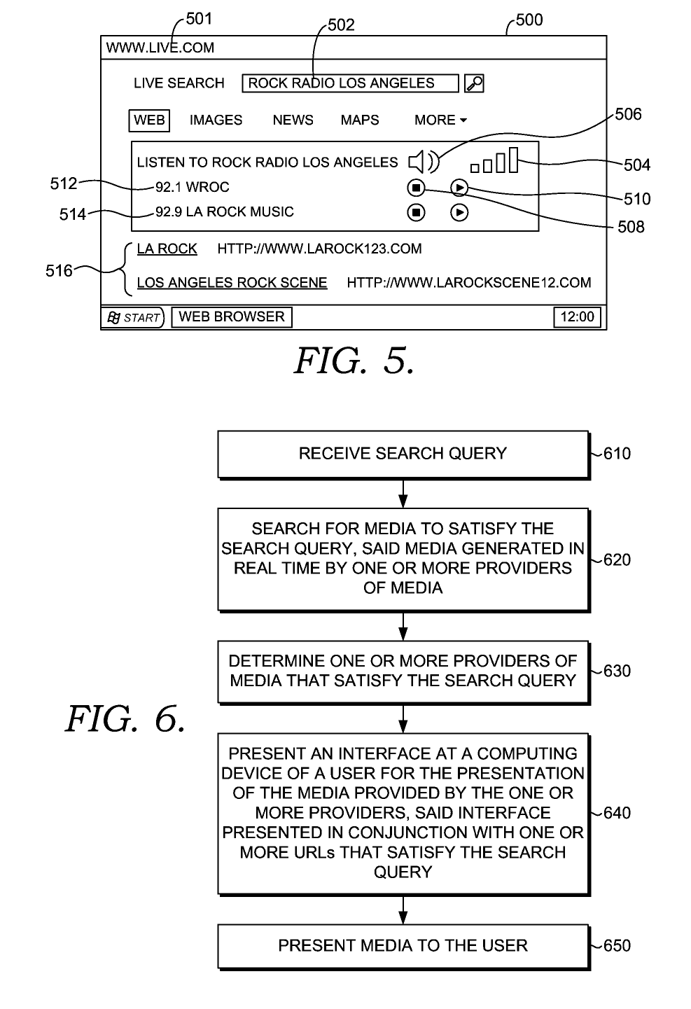

Turning now to FIG. 5, an exemplary diagram depicting a screen shot is presented according to one embodiment of the present invention. User interface 500 includes a window 501 depicting a set of search results generated by search engine server 204 and communicated for presentation on the user device 206 through the network 202. Search query 502 is depicted in the window 501 and contains descriptors of content that the user of the user device 206 is seeking. The search query 502 would have been initially entered on a home page of the search engine server 204, not depicted in the FIGS.

The search query 502 presented in FIG. 5 contains the elements “rock radio los angeles” that define the content of media being sought. By using one or more search algorithms, the search engine server 204 presents sources of media 512 and 514 provided by media providers 208 and 210. By analyzing the elements of the search query 502, the one or more search algorithms can provide search results that are relevant to the search query 502. In the embodiment of the invention presented in FIG. 5, the elements of the search query 502 indicate that the user is seeking media relating to rock radio from a particular geographic location, in this case, Los Angeles, Calif. Accordingly, the search engine server 204 and one or more search algorithms provide sources of media 512 and 514 for rock radio stations in Los Angeles, Calif.

The sources of media 512 and 514 are presented in conjunction with regular search results 516 that provide links to URLs. Although only two regular search results 516 are presented in FIG. 5, any number of regular search results can be presented, according to embodiments of the present invention.

Upon being presented search results in window 501, a user of the user device 206 can select one of the sources of media 512 and 514, or the user can select one of the search results 516 to be redirected to a URL referenced by the particular search result 516. The user can select one of the sources of media 512 and 514 by double clicking on the visual indication of the particular source of media in the window 501. The double clicking can be accomplished by any suitable user-input device. The user can alternatively select the play icon 510 to select one of the sources of media 512 and 514. Upon receiving a selection of the one or more sources of media 512 and 514, media generated by the corresponding media provider 208 and 210 is presented to the user of the user device 206. The user can select a different source of media 512 or 514 by the same method employed to initially select one of the sources of media 512 or 514. Additionally, a user may select to cease to be presented with a source of media 512 or 514 by selecting the stop icon 508 for the corresponding source of media 512 or 514.

Speaker control 506 provides for muting the audio of the selected sources of media 512 and 514 that are being presented to the user of the user device 206. Volume control 504 permits a user to adjust the volume of the selected sources of media 512 and 514.

With reference now to FIG. 6, a block diagram depicting a method for presenting media is presented, according to an embodiment of the present invention. The method begins at block 610 with the receiving of a search query. The search query can contain elements that describe one or more aspects of media being sought. For instance, the search query 302, presented in FIG. 3, of “classical music” describes aspects of media being sought. The search query can be entered into the user device 206 by a user and communicated to the search engine server 204 through the network 202. Additionally, the one or more aspects of media being sought can include descriptors of a genre of media, as evident in the “classical music” example.

The one or more aspects can also include descriptors of the subject matter being sought by the user. These can include, for example, descriptors relating to a current event or news story. In this manner, the user could be presented with sources of media that are relevant to a current event or news story. For example, a user could enter a search query of “Seattle power outage.” and could be presented with sources of media being generated in real time that are relevant to a power outage in Seattle, Wash. The sources of media could be radio stations that are currently transmitting news segments discussing the power outage.

The media provided by the media providers 208 and 210 can be analyzed to determine aspects of the media. The particular aspects can be the genre of music, the subject matter of the media, or any other useful aspect. The aspects can be embedded in the media to aid in the analysis. In other embodiments of the invention, content recognition techniques can be applied to the media to determine different aspects of the media. The content recognition techniques can involve audio recognition methods that analyze the content of the media.

In block 620, media is searched for to satisfy the search query, said media generated in real-time by one or more providers of media. The one or more providers of media can be the media providers 208 and 210 described in relation to FIG. 2. The searching can be implemented by the search engine server 204 through the use of one or more search algorithms.

One or more providers of media that satisfy the search query are determined in block 630. In block 640 an interface is presented at a computing device of a user entering the search query for the presenting of the media provided by the one or more providers. The interface is presented in conjunction with links to one or more URLs that satisfy the search query. A more detailed representation of the interface is discussed and presented in accordance with FIGS. 3-5, above. The media is then presented to the user in block 650.

The media can be ranked in order of their relevance to the received search query. Any number of ranking criteria can be used, in addition to traditional search algorithm ranking techniques. Additionally, the media may be ranked in order of increasing geographic distance from the geographic location of the user generating the search query. The geographic location of the user generating the search query can be determined by analyzing the IP address of the user device 206 being used by the user. This technique of analyzing the IP address of a device in order to determine a likely geographic location of the device is referred to as reverse IP lookup.

Further, the geographic location can be determined through location information extracted from the search query. The location information can take the form as depicted in the search 502 in FIG. 5. In that embodiment, the search query 502 of “rock radio los angeles” indicates that a user is seeking rock radio stations in Los Angeles, Calif.

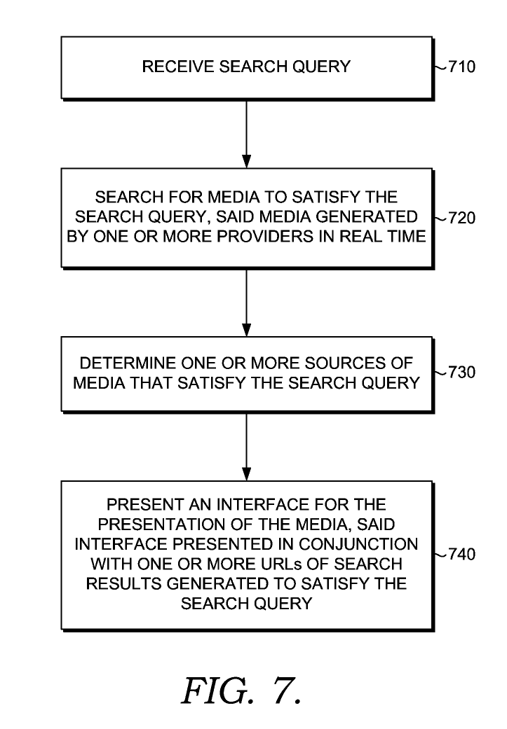

Turning now to FIG. 7, a block diagram depicting a method for presenting media is presented, according to an embodiment of the present invention. A search query is received at block 710. The search query can contain elements that describe one or more aspects of media being sought. For instance, the search query 302, presented in FIG. 3, of “classical music” describes aspects of media being sought. The search query can be entered into the user device 206 by a user and communicated to the search engine server 204 through the network 202. Additionally, the one or more aspects of media being sought can include descriptors of a genre of media, as evident in the “classical music” example.

The one or more aspects can also include descriptors of the subject matter being sought by the user. These can include, for example, descriptors relating to a current event or news story. In this manner, the user could be presented with sources of media that are relevant to a current event or news story. For example, a user could enter a search query of “Seattle power outage,” and could be presented with sources of media being generated in real time that are relevant to a power outage in Seattle, Wash. The sources of media could be radio stations that are currently transmitting news segments discussing the power outage.

The media provided by the media providers 208 and 210 can be analyzed to determine aspects of the media. The particular aspects can be the genre of music, the subject matter of the media, or any other aspect of the media. The aspects can be embedded in the media to aid in the analysis. In other embodiments of the invention, content recognition techniques can be applied to the media to determine different aspects of the media. The content recognition techniques can involve audio recognition methods that analyze the content of the media.

Media is searched for to satisfy the search query in block 720. The media can be generated in real-time by one or more providers of media. The one or more providers of media can be the media providers 208 and 210 described in relation to FIG. 2. The searching can be implemented by the search engine server 204 through the use of one or more search algorithms. In block 730, one or more sources of media that satisfy the search query are determined.

At block 740, an interface is presented for the presentation of said media in conjunction with one or more URLs of search results generated to satisfy the search query received in block 710. The interface is presented in conjunction with links to one or more URLs that satisfy the search query. A more detailed representation of the interface is discussed and presented in accordance with FIGS. 3-5, above. The sources of media can be presented in an order based on a predefined set of rules. Any number of rules can be used, in addition to traditional search algorithm ranking techniques. Additionally, the rules can dictate that the sources of media be ranked in order of increasing geographic distance from the geographic location of the user generating the search query. The geographic location of the user generating the search query can be determined by analyzing the IP address of the user device 206 being used by the user. This technique of analyzing the IP address of a device in order to determine a likely geographic location of the device is referred to as reverse IP lookup.

Further, the geographic location can be determined through location information extracted from the search query. The location information can take the form as depicted in the search 502 in FIG. 5. In that embodiment, the search query 502 of “rock radio los angeles” indicates that a user is seeking rock radio stations in Los Angeles, Calif.

Instances can arise where one particular source of media is presented. These instances can be governed by a set of conditions that dictate that the one particular source be displayed when a search query contains a unique identifier of the particular source. For example, a search query of a radio station's call sign would result in the user being presented with a source of media for that particular radio station.

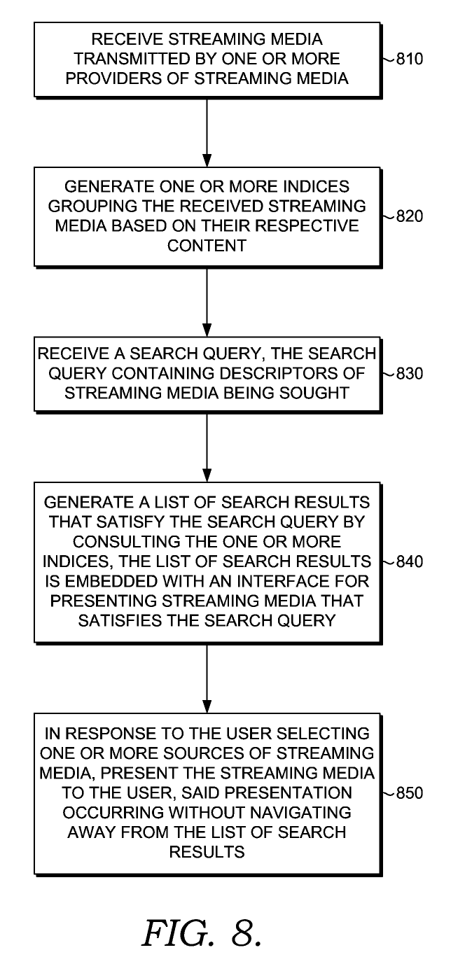

With reference now to FIG. 8, a block diagram depicting a method for presenting streaming media to a user is presented, according to an embodiment of the present invention. The method begins in block 810 by receiving streaming media transmitted by one or more providers of streaming media. The streaming media can be received by a component that serves to aggregate the one or more providers of streaming media. The component can include means to receive broadcast communications, as well as communications through the network 202. In addition, multiple components can be used to receive transmitted streaming media.

In block 820, one or more indices grouping the received streaming media based on their respective content are generated. The content of the received streaming media can be determined by analyzing content identifiers embedded in the streaming media. The content identifiers can be embedded using the standard Radio Broadcast Data System (RDS) used in North America or Radio Data System used in other parts of the world. Such systems provide for the embedding of information describing the content of radio broadcasts with the transmission itself through the use of a sub-carrier. The content identifiers can take other forms, such as “content tags” generated by the providers of the streaming media. The “content tags” can be separate from the streaming media or embedded within the streaming media. In embodiments of the invention that rely on the providers of the sources of streaming media to identify the content of the streaming media, less computing resources may be required, as the media will not need to be analyzed to determine it's respective content. These embodiments of the invention could then be limited to trusted providers of sources of streaming media. A provider would be trusted if users could rely on the provider to provide accurate identification of the content of their respective sources of streaming media.

In other embodiments of the invention, content recognition techniques can be applied to the media to determine different aspects of the media. The content recognition techniques can involve audio and/or video recognition methods that analyze the content of the media. In these embodiments of the invention additional computing resources may be required to apply the content recognition techniques. Since the providers of the sources of streaming media would not be relied upon to accurately identify the content of the streaming media, users could have greater confidence that content of the sources of media was accurately identified. Additionally, the content recognition techniques can also be applied to sources of streaming media that provide “content tags” or other content identifying information.

Embodiments of the present invention can therefore provide a user with a choice between the methods of determining the content of the sources of streaming media. A user could then decide to rely on the providers of sources of streaming to identify the content, or if they desire a higher level of confidence they can choose to use the content recognition techniques. For example, if a user chooses to rely on the providers for identification of the content, the media can be presented to the user with minimal or no advertising, or for a reduced fee or without a fee altogether. While if the user desires to use the content recognition techniques, the media can be presented with additional advertising or the user can be charged a greater fee for the service.

Continuing with FIG. 8, a search query is received at block 830. The search query can contain descriptors of streaming media being sought by the user. For instance, the search query 302, presented in FIG. 3, of “classical music” contains descriptors of media being sought, in this case “classical” and “music.” The search query can be entered into the user device 206 by a user and communicated to the search engine server 204 through the network 202. Additionally, the one or more descriptors of media being sought can include descriptors of a genre of media, as evident in the “classical music” example.

The one or more aspects can also include descriptors of the subject matter being sought by the user. These can include, for example, descriptors relating to a current event or news story. In this manner, the user could be presented with sources of media that are relevant to a current event or news story. For example, a user could enter a search query of “Seattle power outage,” and could be presented with sources of media being generated in real time that are relevant to a power outage in Seattle, Wash. The sources of media could be radio stations that are currently transmitting news segments discussing the power outage.

A list of search results is generated that satisfy the search query by consulting the one or more indices in block 840. By analyzing the descriptors contained in the search query and those in the one or more indices, a list of search results may be generated. For instance, if the search query contains descriptors for “classical music,” the one or more indices can be consulted to determine sources of media that provide classical music. The list of sources of media that provide classical music can then be provided to the user. The list of search results is embedded with an interface for presenting streaming media that satisfied the search query. A more detailed description of this interface and its operation is provide in relation to FIGS. 3-5, above.

The streaming media is then presented to the user in response to the user selecting one of the one or more sources of streaming media in block 850. The presentation can occur without the user navigating away from the list of search results, as the interface is integral to search results web page.

Many different arrangements of the various components depicted, as well as components not shown, are possible without departing from the spirit and scope of the present invention. For instance, a user can be presented with a search results page that contains multiple ‘tabs’ for different types of search results that satisfy a search query issued by the user. For instance, one tab may be for ‘web’ results, another for ‘pictures,’ and additional tabs can be presented as desired. In accordance with embodiments of the present invention, a tab can be presented for sources of media as discussed in relation to FIGS. 3-7. A tab for sources of ‘streaming media’ can be provided in accordance with embodiments of the invention discussed in relation to FIG. 8.

Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. One or more computer-readable storage media having computer-useable instructions embodied thereon for performing a method of presenting media, the method comprising:
receiving a search query, the search query containing elements that describe one or more aspects of media being sought;
searching for media to satisfy the search query, said media being generated in real time by one or more providers of media;
determining the one or more providers of media that satisfy the search query; and
presenting an interface at a computing device of a user for the presentation of said media provided by the one or more providers, said interface being presented in a separate area of a user interface of the computing device from one or more URLs corresponding with regular search results for the search query.

2. The media of claim 1, wherein the elements that describe the one or more aspects of the media being sought include descriptors of a genre of media.

3. The media of claim 1, wherein the elements that describe the one or more aspects of the media being sought include descriptors of the subject matter of media.

4. The media of claim 1, wherein searching for media to satisfy the search query comprises analyzing media provided by the one or more providers to determine the one or more aspects of the media.

5. The media of claim 4, wherein the one or more aspects of the media are embedded in the media.

6. The media of claim 4, wherein the one or more aspects of the media is determined by applying content recognition techniques to the media.

7. The media of claim 4, wherein a description of the media is defined by consulting a database that defines one or more descriptors for sources of media content.

8. The media of claim 1, wherein presenting said media comprises presenting the one or more providers with the media, in a rank in order of their relevance to the search query.

9. The media of claim 8, wherein ranking the one or more providers of media comprises ranking media in order of increasing geographic distance from the geographic location of the user generating the search query.

10. The media of claim 8, wherein the geographic location of the user generating the search query is determined through methods selected from the list comprising:
IP lookup techniques; and
geographic location information extracted from the search query.

11. A method for presenting media, the method comprising:
receiving a search query, the search query containing descriptors of the media being sought;
searching for media to satisfy the search query, said media comprising media being generated by one or more providers in real time;
determining one or more sources of media that satisfy the search query; and
presenting an interface for the presentation of the media, said interface being presented in a separate area of a user interface of the computing device from one or more URLs corresponding with regular search results for the search query.

12. The method of claim 11, wherein searching for media to satisfy the search query comprises:
when the media is embedded with descriptors of the media, analyzing said descriptors to determine which one or more sources of media being generated by the one or more providers is most likely to satisfy the search query.

13. The method of claim 11, wherein presenting the interface for the presentation of the media comprises presenting one or more sources of media in an order based on a predefined set of rules.

14. The method of claim 13, wherein the predefined set of rules dictate that sources of media are presented in an order based on their geographic location in relation to a user generating the search query.

15. The method of claim 13, wherein the predefined set of rules dictate that only one source of media content is presented when predefined conditions are satisfied.

16. A method for presenting streaming media to a user, the method comprising:
receiving streaming media transmitted by one or more providers of streaming media;
generating one or more indices grouping the received streaming media based on their respective content;
receiving a search query, the search query containing descriptors of streaming media being sought; and
generating a list of search results that satisfy the search query by consulting the one or more indices, wherein the list of search results is embedded with an interface for presenting streaming media that satisfies the search query.

17. The method of claim 16, wherein generating the one or more indices grouping the received streaming media comprises determining the content of the streaming media according to one or more techniques selected from the group comprising: consulting content information embedded into the streaming media and performing recognition techniques that analyze the substance of the streaming media to determine the content of the streaming media.

18. The method of claim 16, wherein the streaming media is presented in the interface in an ordered manner according to a relevance of the streaming media to the search query.

19. The method of claim 18, wherein when the search query contains an identifier of a specific source of streaming media, defining the specific source of streaming media referenced by the identifier to be more relevant than other sources of streaming media.

20. The method of claim 16, wherein the descriptors of streaming media being sought are selected from a list comprising:
descriptors defining one or more genres of streaming media; and
descriptors defining a subject matter of the streaming media.
